(19) United States
(12) Patent Application Publication
(10) Pub. No.: US 2021/0125031 A1
(43) Pub. Date: Apr. 29, 2021

(54) METHOD AND SYSTEM FOR GENERATING ASPECTS ASSOCIATED WITH A FUTURE EVENT FOR A SUBJECT

(71) Applicant: RUBIKLOUD TECHNOLOGIES INC., Toronto (CA)

(72) Inventors: Brian KENG, Toronto (CA); Neil VEIRA, Toronto (CA); Thang DOAN, Montreal (CA)

(21) Appl. No.: 16/662,370

(22) Filed: Oct. 24, 2019

(51) Int. Cl. G06N 3/04; G06N 3/08; G06N 20/20; G06Q 10/04

(52) U.S. Cl. CPC G06N 3/0454; G06Q 10/04; G06N 20/20; G06N 3/084

(57) ABSTRACT

Provided is a system and method for generating at least one aspect associated with a future event for a subject using historical data. The method including: determining a subject embedding using a recurrent neural network (RNN), input to the RNN includes historical events of the subject from the historical data, each historical event including by an aspect embedding, the RNN trained using aspects associated with events of similar subjects from the historical data; generating at least one aspect of the future event for the subject using a generative adversarial network (GAN), input to the GAN includes the subject embedding, the GAN trained with subject embeddings determined using the RNN for other subjects in the historical data; and outputting the at least one generated aspect.

### TECHNICAL FIELD

The following relates generally to data processing, and more specifically, to a method and system for generating aspects associated with a future event for a subject.

### BACKGROUND

Predicting aspects of a future event can generally be undertaken where there is sufficient historical data to provide a sufficiently accurate prediction. For example, for retailers, they may rely on extensive customer and product data to better understand customer behaviour and predict future purchases (events) of items (aspects) by the customer (subject). However, this prediction can provide insufficiently accurate predictions for new subjects or infrequent events in the historical data; for example, for new or infrequent customers for which historical transaction data is limited.

### SUMMARY

In an aspect, there is provided a method for generating at least one aspect associated with a future event for a subject using historical data, the historical data comprising a plurality of aspects associated with historical events, the method executed on at least one processing unit, the method comprising: receiving the historical data; determining a subject embedding using a recurrent neural network (RNN), input to the RNN comprises historical events of the subject from the historical data, each historical event comprising by an aspect embedding, the RNN trained using aspects associated with events of similar subjects from the historical data; generating at least one aspect of the future event for the subject using a generative adversarial network (GAN), input to the GAN comprises the subject embedding, the GAN trained with subject embeddings determined using the RNN for other subjects in the historical data; and outputting the at least one generated aspect.

In a particular case of the method, the aspect embedding comprises at least one of a moniker of the aspect and a description of the aspect.

In another case of the method, the RNN comprises a long short term memory (LSTM) model trained using a multi-task optimization approach.

In yet another case of the method, the multi-task optimization approach comprises a plurality of prediction tasks, the LSTM randomly sampling which of the prediction tasks to predict for each training step.

In yet another case of the method, the prediction tasks comprise: predicting whether the aspect is a last aspect to be predicted in a compilation of aspects; predicting a grouping or category of the aspect; and predicting an attribute associated with the aspect.

In yet another case of the method, the GAN comprises a generator and a discriminator collectively performing a min-max game.

In yet another case of the method, the discriminator maximizes an expected score of real aspects and minimizes a score of generated aspects, and wherein the generator maximizes a likelihood that the generated aspect is plausible, where plausibility is determined by the output of the discriminator.

In yet another case of the method, the similarity of subjects is determined using a distance metric on the subject embedding.

In yet another case of the method, the method further comprising generating further aspects for subsequent future events by iterating the determining of the subject embedding and the generating of the at least one aspect, using the previously determined subject embeddings and generated aspects as part of the historical data.

In yet another case of the method, aspects are organized into compilations of aspects that are associated with each of the events in the historical data and the future event.

In another aspect, there is provided a system for generating at least one aspect associated with a future event for a subject using historical data, the historical data comprising a plurality of aspects associated with historical events, the system comprising one or more processors in communication with a data storage, the one or more processors configurable to execute: a data acquisition module to receive the historical data; an RNN module to determine a subject embedding using a recurrent neural network (RNN), input to the RNN comprises historical events of the subject from the historical data, each historical event comprising by an aspect embedding, the RNN trained using aspects associated with events of similar subjects from the historical data; and a GAN module to generate at least one aspect of the future event for the subject using a generative adversarial network (GAN), input to the GAN comprises the subject embedding, the GAN trained with subject embeddings determined using the RNN for other subjects in the historical data, and output the at least one generated aspect.

In a particular case of the system, the aspect embedding comprises at least one of a moniker of the aspect and a description of the aspect.

In another case of the system, the RNN comprises a long short term memory (LSTM) model trained using a multi-task optimization approach.

In yet another case of the system, the multi-task optimization approach comprises a plurality of prediction tasks, the LSTM randomly sampling which of the prediction tasks to predict for each training step.

In yet another case of the system, the prediction tasks comprise: predicting whether the aspect is a last aspect to be predicted in a compilation of aspects; predicting a grouping or category of the aspect; and predicting an attribute associated with the aspect.

In yet another case of the system, the GAN comprises a generator and a discriminator collectively performing a min-max game.

In yet another case of the system, the discriminator maximizes an expected score of real aspects and minimizes a score of generated aspects, and wherein the generator maximizes a likelihood that the generated aspect is plausible, where plausibility is determined by the output of the discriminator.

In yet another case of the system, the similarity of subjects is determined using a distance metric on the subject embedding.

In yet another case of the system, the one or more processors further configurable to execute a pipeline module to generate further aspects for subsequent future events by iterating the determining of the subject embedding by the RNN module and the generating of the at least one aspect by the GAN module, using the previously determined subject embeddings and generated aspects as part of the historical data.

In yet another case of the system, aspects are organized into compilations of aspects that are associated with each of the events in the historical data and the future event.

These and other embodiments are contemplated and described herein. It will be appreciated that the foregoing summary sets out representative aspects of systems and methods to assist skilled readers in understanding the following detailed description.

### BRIEF DESCRIPTION OF THE DRAWINGS

The features of the invention will become more apparent in the following detailed description in which reference is made to the appended drawings wherein:

FIG. 1 is a schematic diagram of a system for generating at least one aspect associated with a future event for a subject using historical data, in accordance with an embodiment;

FIG. 2 is a flowchart of a method for generating at least one aspect associated with a future event for a subject using historical data, in accordance with an embodiment;

FIG. 3 is a diagrammatic example of embedding subjects via multi-task learning, in accordance with the system of FIG. 1;

FIG. 4 is a diagrammatic example of basket sequence generation for a retail datasets example, in accordance with the system of FIG. 1;

FIG. 5 is a visualization of product embeddings in a 2D space for the a retail datasets example of FIG. 4;

FIG. 6 is a histogram plot comparing the frequency distributions of categories between baskets generated using the system of FIG. 1 and real baskets for an example experiment;

FIG. 7 is a histogram plot comparing the frequency distributions of brands between baskets generated using the system of FIG. 1 and real baskets for the example experiment of FIG. 6;

FIG. 8 is a histogram plot comparing the frequency distributions of prices between baskets generated using the system of FIG. 1 and real baskets for the example experiment of FIG. 6;

FIG. 9 is a histogram plot comparing the frequency distributions of basket sizes between baskets generated using the system of FIG. 1 and real baskets for the example experiment of FIG. 6;

FIG. 10 is a plot of a percentage of the top-k most common real sequential patterns that are also found in the generated data as k varies from 1 to 1000 for the example experiment of FIG. 6;

FIG. 11 shows scatter plots for basket representations as bags-of-products vectors at a category level, projected using t-SNE, for the example experiment of FIG. 6; and

FIG. 12 shows scatter plots for basket representations as bags-of-products vectors at a category level, projected using PCA, for the example experiment of FIG. 6.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following relates generally to data processing, and more specifically, to a method and system for generating aspects associated with a future event for a subject.

For the sake of clarity of illustration, the following disclosure generally refers to the implementation of the present embodiments with respect to retail datasets; however, it is appreciated that the embodiments described herein can be used for any suitable application of where input data augmentation is required. In the retail datasets example, future events are future purchases of one or more items and the subject is a given customer.

In a further example, the embodiments described herein could be used to predict utility consumption of a household (as the purchaser) across electricity, internet, gas, hydro etc. (as the products). The “basket” could be the quantity of these things over a fixed time period, such as a month. The system could generate new populations of data for people and their behaviour.

In a further example, the embodiments described herein could be used to predict airline flight planning data. The historical data could include consumer flyers (as the purchaser) and their flights (as the products). In this case, the basket could include the flight, including the number of passengers, upgrades, etc. The system could then predict flight purchasing patterns over time for certain trained populations

In a further example, the embodiments described herein could be used to predict hospital services utilization. The historical data could include patients (as the purchaser) utilizing different medications and/or services (as the products) while at a hospital. The basket of products could be what services and/or medications the patients use, on a daily basis, during their stay. Their pathology could be the contextual information about each patient which is analogous to the demographics described herein in the retail datasets example.

In the retail datasets example, retailers often collect, store, and utilize massive amounts of consumer behaviour data through their customer tracking efforts, such as their customer loyalty programs. Sources such as customer-level transactional data, customer profiles, and product attributes allow the retailer to better service their customers by utilizing data mining techniques for customer relationship management (CRM) and direct marketing systems. Better data mining techniques for CRM databases can allow retailers to understand their customers more effectively, leading to increased loyalty, better service and ultimately increased sales.

Modelling customer behaviour is a complex problem with many facets, such problems being typical for modelling with incomplete datasets. For example, a retailer's loyalty data provides a censored view into a customer's behaviour because it only shows the transactions for that retailer, leading to noisy observations. In addition, the sequential nature of consumer purchases adds additional complexity as changes in behaviour and long-term dependencies should be taken into account. Additionally, in many cases, a large number of customers multiplied by a large catalog of products results in a vast amount of transactional data, but can be simultaneously very sparse at the level of individual customers.

There are indirect approaches to modelling customer behaviour for specific tasks. For example, techniques that utilize customer-level transactional data such as customer lifetime value, recommendations, and incremental sales, can formulate these tasks as supervised learning problems. There are other direct approaches to modelling customer behaviour through the use of simulators. For example, using customer marketing simulators to understand decision support and understand how behavioural phenomena affect consumer decisions. Other simulator approaches simulate direct marketing activities to find an ideal marketing policy to maximize a pre-defined reward over time. However, these techniques are focused on generating an optimal marketing policy and generally do not generate realistic simulations of customer transactional data.

Some approaches to generating modelling can learn realistic distributions from the data in different contexts. For example, in one approach, realistic orders from an e-commerce dataset can be generated. While in this approach the model can learn complex relationships between customers and products to generate realistic simulations of customer orders, it does not consider an important aspect of how customer behaviour changes over time.

Some approaches for learning a representation of customers from their transactional data borrow inspiration from natural language processing (NLP) by embedding customers into a common vector space based of their transaction sequences. For instance, learning the embeddings by adapting the paragraph vector-distributed bag-of-words or the n-skip-gram models. The underlying idea behind these approaches is that by solving an intermediate task such as predicting the next word in a sentence or the next item a customer will purchase, the system can learn features that have good predictive power and are meaningful for a wide variety of tasks. However, this approach alone does not learn the sequential behavior of a customer because it only looks locally at adjacent transactions.

Other approaches can use collaborative filtering to predict a customer's preference for items; although such approaches usually do not directly predict a customer's next purchase. Such approaches can mimic a recurrent neural network (RNN) by feeding historical transaction data as input to a neural network which predicts the next item. However, similarly to the above, this approach alone does not learn the sequential behavior of a customer because it only looks locally at adjacent transactions. For collaborative filtering in particular, generally there is not even a prediction of the next item, but rather there is a reliance on an unsupervised clustering-like technique in order to find products the customer will “like”.

In the retail datasets example, a customer's state with respect to a given retailer (i.e., the types of products they are interested in and the amount of money they are willing to spend) evolves over time. In marketing research, some agent-based approaches have been used in building simple simulations of how customers interact and make decisions. Data mining and machine learning approaches can be used to model a customer's state in the context of direct marketing activities. Some approaches model the problem in the reinforcement learning framework attempting to learn the optimal marketing policy to maximize rewards over time. These approaches use various techniques to represent and simulate the customer's state over time. However, these approaches do not use the customer's state to generate its future orders, but rather consider it more narrowly in the context of the defined reward. Other approaches generate plausible customer e-commerce orders for a given product using a Generative Adversarial Network (GAN). Given a product embedding, some approaches generate a tuple containing a product embedding, customer embedding, price, and date of purchases, which summarizes a typical order. This approach using a GAN can provide insights into product demand, customer preferences, price estimation and seasonal variations by simulating what are likely potential orders. However, such approach only generates orders and does not directly model customer behaviour over time.

In embodiments of the present disclosure, approaches are provided to learn distribution of subject-level aspects of future events over time from a subject-level dataset of past events; in the retail datasets example, learning a distribution of customer-level aspects of customer orders of products over time from a customer-level dataset of retail transactions. These approaches can generate samples of both subjects and traces of aspects associated with their events over time. Advantageously, this allows the system to essentially generate new subject-level event datasets that match the distributional properties of the historical data. Advantageously, this allows for further applications. For instance, in the retail datasets example, generating a distribution of likely products to be purchased by an individual customer to derive insights, or by providing external researchers with access to generated data for a dataset that otherwise would be restricted due to privacy concerns.

In an embodiment of the present disclosure, an approach is provided that generates subject-level event data using a combination of Generative Adversarial Networks (GAN) and Recurrent Neural Network (RNN). An RNN is trained to generate a subject embedding by using a multi-task learning approach. The inputs to the RNN are embeddings of one or more aspects of a future event derived from textual descriptions of the aspects. This allows the system to describe the subject state given previous events associated with the subject and/or similar subjects. Values for aspects of a future event are determined based on historical values for such aspect of similar subjects. A GAN, trained by conditioning on a subject embedding at a current time, is used to predict a value for an aspect of a future event for a given subject. In some cases, the future event can have a compilation of aspects associated with it. In this case, the prediction is repeated until all values of aspects associated with the future event are determined. Advantageously, this provides a prediction for multiple aspects of a single subject-level event. In some cases, the predicted aspect values can be fed back into the RNN to generate a prediction for a subsequent event associated with the subject by then repeating the above steps. While some of the present embodiments describe using an RNN, it is understood that any suitable sequential dependency (time series) model can be used; for example, Bayesian structural time series, ARIMA models, and the like. While some of the present embodiments describe using a GAN, it is understood that any suitable generative model can be used; for example, variational auto encoders, convolutional-based neural networks, probabilistic graph networks, and the like.

In general, “embedding” as used herein means encoding a discrete variable (e.g. products) into a real-valued vector. In an example, if there are 100,000 products, it may not be scalable to put this many one-hot binary variables into a model. However, the 100,000 products can be “embedded” into a smaller (e.g. 100) dimensional real-valued vector; which is much more computationally efficient. Generally, the system tries to ensure that each product is placed in a reasonable location in the 100-Dimesional vector space. In a particular case, the system can use similarities between products to achieve a global optimum of placement. One way to compute similarity is using textual descriptions; where similar descriptions mean they will be closer together in the vector space and vice versa. Other cases can use other information for placement, such as using basket information; items that appear in the same “context” (other items in the basket) will be similar to each other and should be placed closer together in the vector space.

In the present embodiments, the GAN generates a new data point by sampling from a random distribution (in some cases, a multi-variate Gaussian distribution) and then putting it through a neural network to generate the data point. In some cases, the GAN can be conditioned by having an additional input to this process that sets the “context” of how the GAN should interpret the sample of the random distribution. During training, each training sample should provide this additional context and then the system should be able to generate new data points from the context. In the retail datasets example, the GAN can be conditioned based on the customer embedding at the current time.

The present inventors conducted example experiments to demonstrate the effectiveness of the present embodiments using several qualitative and quantitative metrics. The example experiments show that the generator can reproduce the relative frequencies of various product features including types, brands, and prices to within a 5% difference. The example experiments also show that the generated data retains all of the strongest associations between products in the real data set. The example experiments also show that most of the real and generated baskets are indistinguishable, with a classifier trained to separate the two being able to achieve an accuracy of only 63% at the category level.

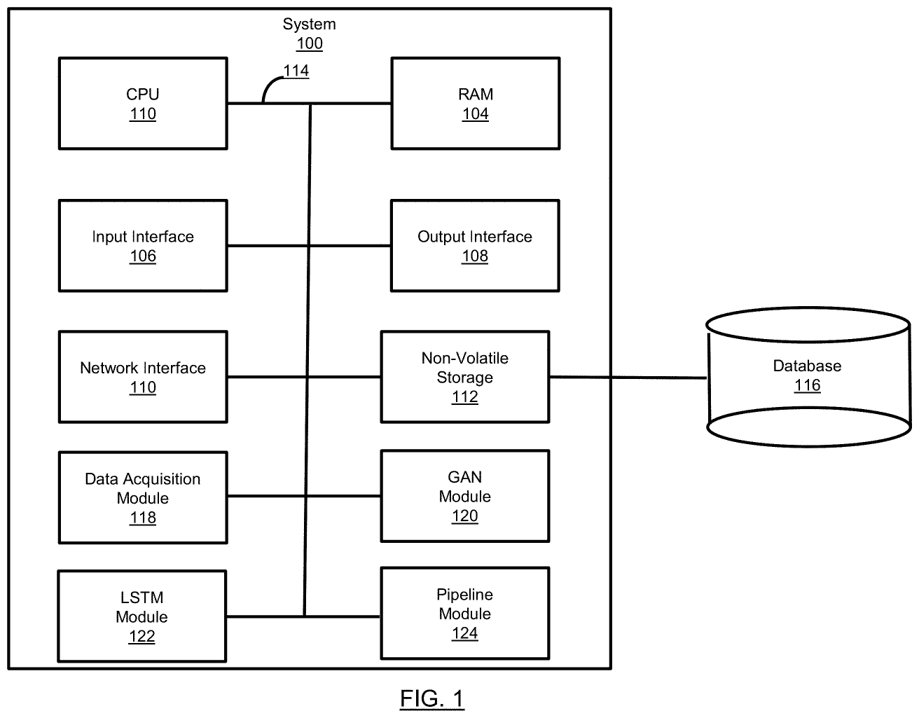

Referring now to FIG. 1, a system 100 for generating aspects associated with a future event for a subject, in accordance with an embodiment, is shown. In this embodiment, the system 100 is run on a server. In further embodiments, the system 100 can be run on any other computing device; for example, a desktop computer, a laptop computer, a smartphone, a tablet computer, a mobile device, a smartwatch, or the like.

In some embodiments, the components of the system 100 are stored by and executed on a single computer system. In other embodiments, the components of the system 100 are distributed among two or more computer systems that may be locally or globally distributed.

FIG. 1 shows various physical and logical components of an embodiment of the system 100. As shown, the system 100 has a number of physical and logical components, including a central processing unit (“CPU”) 102 (comprising one or more processors), random access memory (“RAM”) 104, an input interface 106, an output interface 108, a network interface 110, non-volatile storage 112, and a local bus 114 enabling CPU 102 to communicate with the other components. CPU 102 executes an operating system, and various modules, as described below in greater detail. RAM 104 provides relatively responsive volatile storage to CPU 102. The input interface 106 enables an administrator or user to provide input via an input device, for example a keyboard and mouse. The output interface 108 outputs information to output devices, such as a display and/or speakers. The network interface 110 permits communication with other systems, such as other computing devices and servers remotely located from the system 100, such as for a typical cloud-based access model. Non-volatile storage 112 stores the operating system and programs, including computer-executable instructions for implementing the operating system and modules, as well as any data used by these services. Additional stored data, as described below, can be stored in a database 116. During operation of the system 100, the operating system, the modules, and the related data may be retrieved from the non-volatile storage 112 and placed in RAM 104 to facilitate execution.

In an embodiment, the system 100 further includes a data acquisition module 118, a GAN module 120, an RNN module 122, and a pipeline module 124. In some cases, the modules 118, 120, 122, 124 can be executed on the CPU 110. In further cases, some of the functions of the modules 118, 120, 122, 124 can be executed on a server, on cloud computing resources, or other devices. In some cases, some or all of the functions of any of the modules 118, 120, 122, 124 can be run on other modules.

Forecasting is the process of obtaining a future value for a subject using historical data. Machine learning techniques, as described herein, can use the historical data in order to train their models and thus produce reasonably accurate forecasts when queried.

Generative adversarial networks (GANs) are a class of generative models aimed at learning a distribution. This approach was founded on the game theoretical concept of two-player zero-sum games, wherein two players each try to maximize their own utility at the expense of the other player's utility. By formulating the distribution learning problem as such a game, a GAN can be trained to learn good strategies for each player. A generator G aims to produce realistic samples from this distribution while a discriminator D tries to differentiate fake samples from real samples. By alternating optimization steps between the two components, the generator ultimately learns the distribution of the real data.

The generator network G:Z→X is a mapping from a high-dimensional noise space Z= [symbol] ^{d}^{_{z}} to the input space X on which a target distribution f_{X} is defined. The generator's task consists of fitting the underlying distribution of observed data f_{X} as closely as possible. The discriminator network D:X→ [symbol] ∩[0,1] scores each input with the probability that it belongs to the real data distribution f_{X} rather than the generator G. The GAN optimization minimizes the Jensen-Shannon divergence (JS) between the real and generated distributions. In some cases, the JS metric can be replaced by the Wasserstein-1 or Earth-Mover divergence. The system 100 can use a customized version of this approach, the Wasserstein GAN (WGAN) with a gradient penalty. The objective of such approach is given by:

$${min}_{G} {max}_{D} {𝔼}_{x ∼ {f}_{X} ( x )} [ D ( x ) ] + {𝔼}_{x ∼ G ( z )} [ - D ( x ) ] + p ( λ ) , \qquad ( 1 )$$

where p(λ)=λ)∥∇_{\tilde{x}}D(\tilde{x})∥−1)², \tilde{x}=εx+(1−ε)G((Z), ε˜Uniform(0,1), and Z˜f_{Z}(z). Setting λ=0 recovers the original WGAN objective

Embodiments of the system 100 can use the pipeline module 124 that executes a pipeline comprising a GAN model executed by the GAN module 120 and an RNN model executed by the RNN module 122, which are intertwined in a sequence of aspect prediction (also referred to as generation) and subject state updating. The GAN module 120 can train a GAN model to generate a compilation of aspects of a future event (also referred to as a basket) conditioned on a time-sensitive subject representation. The RNN module 122 can train an RNN model, for example a Long Short Term Memory (LSTM) model, using a sequential nature of the subject's state as it interacts with the various aspects. Each of these modules can use uses semantic embeddings of the subjects and the aspects for representational purposes, as defined herein.

To capture semantic relationships between aspects of the event that exist independently of subject interactions, the system 100 can learn aspect representations based on their associated textual descriptions. For example, a corpus can be created comprising a sentence for each aspect as a concatenation of the aspect's moniker and description. In some cases, preprocessing can be applied to remove stopwords and other irrelevant tokens. In the example experiments of the retail datasets example, described herein, an example corpus can contain 11,443 products (as the aspect) that are transacted (as the future event), which has a vocabulary size of 21,894 words. In this example, each transaction can comprise purchasing multiple products in a basket (as the compilation). In some cases, a word2vec skipgram model can be trained on this corpus; for example, using a context window size of 5 and an embedding dimensionality of 128. In some cases, each aspect representation can be defined as an arithmetic mean of the word embeddings in the aspect's moniker and description; particularly, since sums of word vectors can produce semantically meaningful vectors.

To characterize subjects by their past patterns, the RNN module 122 can learn subject embedding representations from historical data. For example, in the retail datasets example, customers can be characterized by their purchase habits by learning customer embedding representations from the customer's transactional data. The RNN module 122 can provide the LSTM model, as input, a sequence of events for a given subject, where each event is defined by an aspect embedding and, in some cases, a time of the event. For example, in the retail datasets example, the input can comprise a sequence of transactions for a given customer, where each transaction is defined by an item embedding and the week of purchase. The LSTM model can be trained to learn the subject's sequential patterns via a multi-task optimization approach. In an embodiment, the output of the LSTM model is fed as inputs one or more prediction tasks that are representative of a customer to track their behaviour. In an example, the inputs could be at least one of the following three prediction tasks:
1) Predicting whether an aspect is a last aspect to be predicted in a compilation of aspects by performing binary classification on each item;
2) Predicting a grouping or category of the next aspect, where the grouping or category associates two or more aspects together (in the retail datasets example, predicting a product category for the next product that will be purchased); and
3) Predicting an attribute associated with the next aspect (in the retail datasets example, predicting the price of the next product that will be purchased).

In the present embodiments, the LSTM can be trained to learn the customer's sequential patterns via a multi-task optimization procedure. When training the LSTM (or other RNN), in general cases, there is a single loss/objective function. In this way, it is given one training data point and it updates the neural network weights by back propagation. However, with a “multi-task optimization”, there may be many different problems, and for each problem, there may be different training data points. The training procedure can use the same neural network (with various modifications to outputs and loss functions) and applies the training data points in sequence to train it. In this way, the neural network is learning to generalize across the problems. This is advantageous for the present embodiments because it is generally desirable for the RNN to learn a general data distribution.

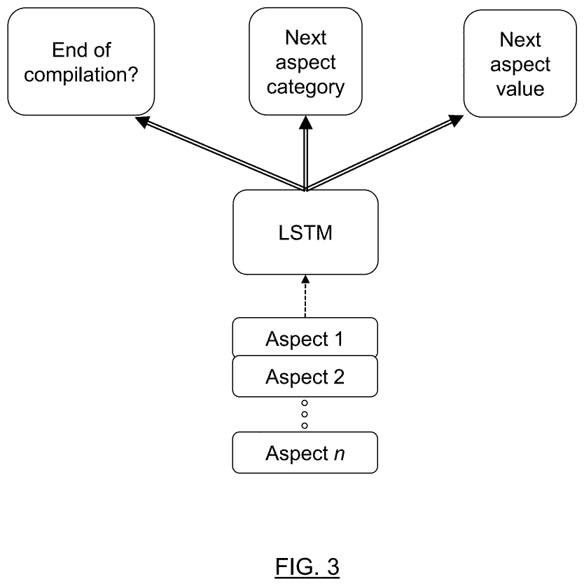

In an embodiment, the RNN module 122 trains the LSTM model so as to maximize the performance of all three prediction tasks by randomly and uniformly sampling a single task in each step and optimizing for this task. After convergence, the hidden state of the LSTM model can be used to characterize a subject's patterns (for example, a customer's purchasing habits), and thus a subject's state. Thus, subjects with similar patterns will be closer together in the resulting embedding space. FIG. 3 diagrammatically illustrates an example of a process of learning this embedding. Embedding subjects via multi-task learning with an LSTM model, where the input is the sequence of aspects associated with events of a subject over time in the historical data. After convergence, the hidden state of the LSTM model can be used to characterize a subject's state.

In order for the network to accurately predict the one or more prediction tasks, it is useful for the network to have some internal representation of what the subject is at that stage (based on all their events up to that point). If the network is accurately predicting the prediction tasks, then the system can advantageously use its internal representation as a proxy for the subject's state; an “embedding” into a high dimensional real vector space.

In an embodiment, to learn aspect distributions, the GAN module 120 can use a conditional Wasserstein GAN. In an optimization process, the GAN module 120 can use a discriminator and a generator in a min-max game. In this game, the discriminator aims to maximize the following loss function:

$${max}_{D} {𝔼}_{x ∼ {f}_{X} ( x )} [ D ( x \vert ( h , w ) ] + {𝔼}_{x ∼ G ( z \vert ( h , w ) )} [ - D ( x \vert ( h , w ) ] + λ ( {‖ {∇}_{\tilde{x}} D ( \tilde{x} \vert ( h , w ) ‖ - 1 )}^{2} \qquad ( 2 )$$

where λ is a penalty coefficient, \tilde{x}=εx+(1−ε)G(z|(h, w)), and ε˜Uniform(0,1). The first term is the expected score (which can be thought of as likelihood) of seeing an aspect x being associated with a given subject in a given timeframe (for example, an item being purchased by a given customer in a given week (h, w)). The second term is the score of seeing another aspect z being associated with the same subject in the same timeframe (for example, another item also being purchased by that same customer and in the same week (h, w)). Taken together, these first two terms encourage the discriminator to maximize the expected score of the real aspects x˜f_{X}(x) given context (h, w) and minimize the score of the generated aspects x˜G(z|(h, w)). The third term the above equation is a regularization penalty to ensure that D satisfies the 1-Lipschitz conditions.

The generator is trained to minimize the following loss function:

$${max}_{G} {𝔼}_{x \text{∼} G ( z \vert ( h w ) )} [ D ( x \vert ( h , w ) ] \qquad ( 3 )$$

The objective aims to maximize the likelihood that the generated aspect x∞G(z|(h, w)) is plausible given the context (h, w), where plausibility is determined by the discriminator D(x|(h, w)). With successive steps of optimization, the GAN module 120 obtains a G which can generate samples that are more similar to a real data distribution.

While the generator learned from Equation (3) can yield realistic product embeddings, in some cases the GAN module 120 may obtain specific instances from a database P={pᵢ}ᵢ₌₁ⁿ of known aspects. This can be useful, for instance in the retail datasets example, to obtain a product recommendation for customer h at week w. Given a generated product embedding G(z|(h, w)), this can be accomplished by computing the closest aspect from the database according to the L₂ distance metric: p=argminₚ_{ᵢ}_{ϵP}∥G(z|(h, w))−pᵢ∥₂². In further cases, other distance metrics can be used, such as cosine distance.

The pipeline module 124 develops a pipeline to generate a sequence for compilations of aspects that will likely be associated with a subject over consecutive timeframes; for instance, in the retail dataset example, a sequence of baskets of items that a customer will likely purchase over several consecutive weeks. The pipeline module 124 incorporates the aspect generator G to produce individual aspects in the compilation as well as the RNN module to model the evolution of a subject's state over a sequence of compilations.

Given a new subject with an event history B₁, B₂, . . . , Bᵢ, where each Bⱼ denotes a compilation of aspects for a given timeframe wⱼ and i≥1, the pipeline module 124 generates a compilation Bᵢ₊₁ for a subsequent timeframe. The pipeline module 124 extracts the subject embedding at timeframe wᵢ, denoted hᵢ, by passing the event sequence through the hidden state of the LSTM model. The pipeline module 124 finds the k most similar subjects from a historical database of known subjects by, for example, determining L₂ distance from hᵢ. Similar to retrieving known aspects from a historical database, as described herein. The pipeline module 124 determines the number of aspects to generate for the given subject in a given timeframe W. To determine this value, the pipeline module 124 uniformly samples from compilation sizes of the compilations associated with the k most similar subjects to retrieve the number of aspects to generate, nᵢ. From the most similar subjects, the pipeline module 124 can get a list of all the associated basket sizes; which forms a distribution, from 1 to max basket size, from which the pipeline module 124 can sample. The GAN module 120 can use the generator network to generate nᵢ aspects via the generator, G(hᵢ, wᵢ).

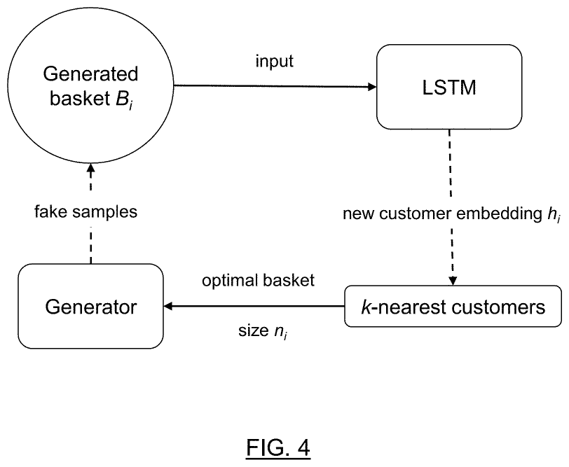

In some cases, the above approach can be extended to generate additional compilations by the RNN module 122 by feeding Bᵢ₊₁ back into the LSTM model, whose hidden state is updated as if the subject had been associated with event Bᵢ₊₁. The updated subject representation hᵢ₊₁ can once again be used to estimate a compilation size nᵢ₊₁ and fed into the generator G(hᵢ₊₁, wᵢ₊₁) which yields a compilation of aspects for the given timeframe wᵢ₊₁. This cycle can be iterated multiple times to generate compilation sequences of arbitrary length. An example of the approach for compilation generation for the retail datasets example is illustrated by PSEUDO-CODE 1 and illustrated in FIG. 4. Note that all values in the PSEUDO-CODE 1 example are also indexed by the customer index c; where the symbol B₀^{c} is used to denote the entire history of customer c.

PSEUDO-CODE 1

Input: LSTM L, generator G, set of historical basket sequences for each
customer
{B₀^{c}}_{c=1}^{C}, hyperparameter k, number of weeks W
for c = 1, ..., C do

Compute initial customer embedding h₀^{c} via L(B₀^{c})
for w = 1, ..., W do

Sample n_{w}^{c} via k-nearest customers of h_{w}^{c}
Generate basket B_{w}^{c} of n_{w}^{c} products from G(h_{w}^{c}, w)
Update the customer embedding with the LSTM:
h_{w+1}^{c} = L(B_{w}^{c}, h_{w}^{c}).
end for

end for

In this manner, the system 100 can efficiently and effectively augment a new subject's event history by predicting their future events for an arbitrary amount of time. In this way, a subject's embedding representation evolves as future events arrive, and therefore might share some common properties with other subjects through their event experiences. The system 100 can derive insights from this generated data by learning a better characterization of the subject's likely events into the future.

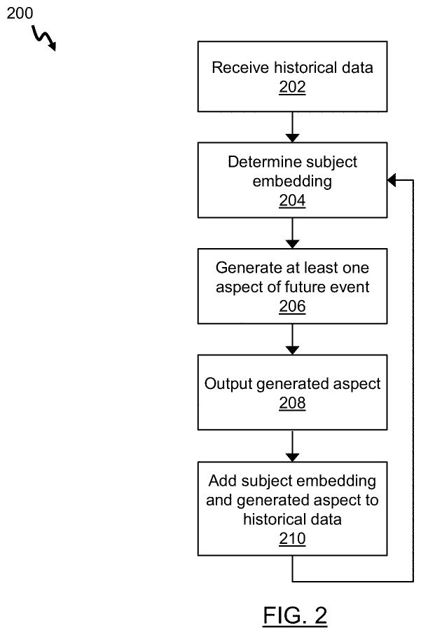

Turning to FIG. 2, a flowchart for a method 200 for generating aspects associated with a future event for a subject, according to an embodiment, is shown. The generating the aspects is based on historical data, for example, as stored in the database 116 or as otherwise received. The historical data comprising a plurality of aspects associated with historical events for the subject and/or other subjects.

At block 202, the data acquisition module 118 receives the historical data comprising the plurality of aspects from the input interface 106, the network interface 110, or the non-volatile storage 112.

At block 204, the RNN module 122 determines a subject embedding using a recurrent neural network (RNN). Input to the RNN comprises historical events of the subject from the historical data, each historical event comprising by an aspect embedding. The RNN is trained using aspects associated with events of similar subjects from the historical data.

At block 206, the GAN module 120 generates at least one aspect of the future event for the subject using a generative adversarial network (GAN). Input to the GAN comprises the subject embedding. The GAN is trained with subject embeddings determined using the RNN for other subjects in the historical data.

At block 208, the GAN module 120, via the output interface 108, the network interface 110, or the non-volatile storage 112, outputs the at least one generated aspect.

At block 210, in some cases, the pipeline module 124 adds the previously determined subject embeddings and generated aspects as part of the historical data. The pipeline module 124 then generates further aspects for subsequent future events (block 208) by iterating the determining of the subject embedding by the RNN module (block 204) and the generating of the at least one aspect by the GAN module (block 208).

The present inventors empirically demonstrated the efficacy of the present embodiments via example experiments. For the retail datasets example, the example experiments compared the compilation data generated by the present embodiments to real collected customer data. Evaluation was first performed with respect to the distributions of key metrics aggregated over the entire data sets, including product categories, brands, prices, and basket sizes. Association rules that exist between products in both data sets were compared. The separability between the real and generated baskets with multiple different basket representations was evaluated.

The present embodiments were evaluated using a data set from an industrial retailer, which consisted of 742,686 transactions over a period of 5 weeks during the summer of 2016. This data is composed of 174,301 customer baskets with an average size of 4.08 items and price of $12.2. A total of 7,722 distinct products and 66,000 distinct customers exist across all baskets.

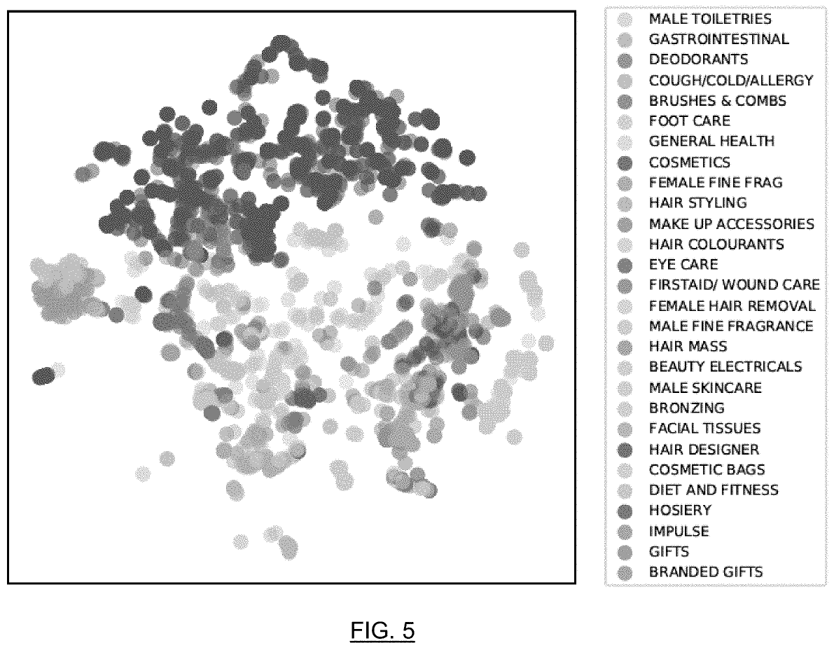

FIG. 5 shows an example of product embedding representations for the example experiments extracted from textual descriptions, as described herein, projected into a 2-dimensional space using a t-SNE algorithm. Products were classified into functional categories such as Hair Styling, Eye Care, and the like. Products from the same category tended to be clustered close together, which reflects the semantic relationships between such products. At a higher level, it was observed that similar product categories also occur in close proximity to one another; for example, the categories of Hair Mass, Hair Styling and Hair Designer are mapped to adjacent clusters, as are the categories of Female Fine Frag and Male Fine Frag. These proximities help basket generation which directly generates product embeddings, while specific products are obtained based on their proximity to other products in the embedding space. As the GAN produces a product embedding (real-valued vector) as its output, this output has to be mapped to an actual product by determining the closest product to the vector. If the products were randomly placed in the vector space, the system might inadvertently map this embedding to a strange product. Advantageously, for the present embodiments, similar products are grouped together in the vector space, thus the probability of mapping to a desirable product is significantly higher.

The RNN module 122 trained the LSTM model on the above data set with multi-task optimization, as described herein, for 25 epochs. For each customer, an embedding was obtained from the LSTM hidden state after passing through all of that customer's transactions. These embeddings were then used by the GAN module 120 to train the conditional GAN model. The GAN was trained for 100 epochs using an Adam optimizer with hyperparameter values of α=0.5 and β=0.9. The discriminator was comprised of two hidden layers of 256 units each with ReLU activation functions, with the exception of the last layer which was free of activation functions. The generator used the same architecture except for the last layer which had a tanh activation function. During training, the discriminator was prioritized by applying five update steps for each update step to the generator. This helped the discriminator converge faster so as to better guide the generator. Once the LSTM and GAN were trained, the pipeline module 124 performed basket sequence generation. For each customer, 5 weeks of baskets were generated following the approach described herein.

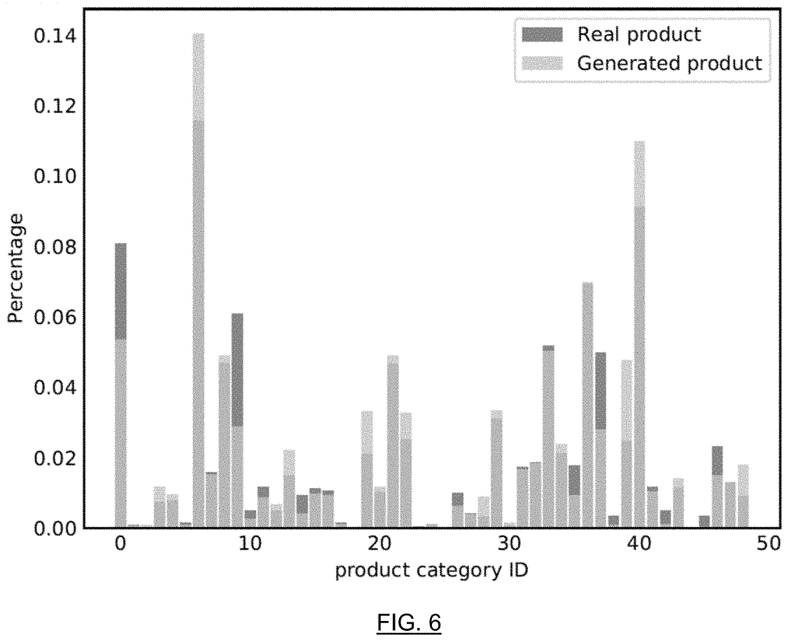

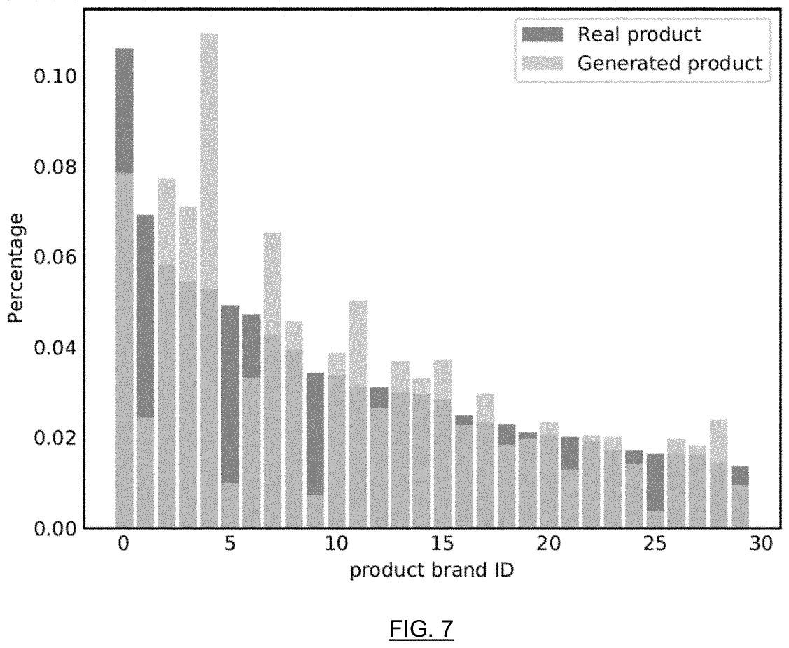

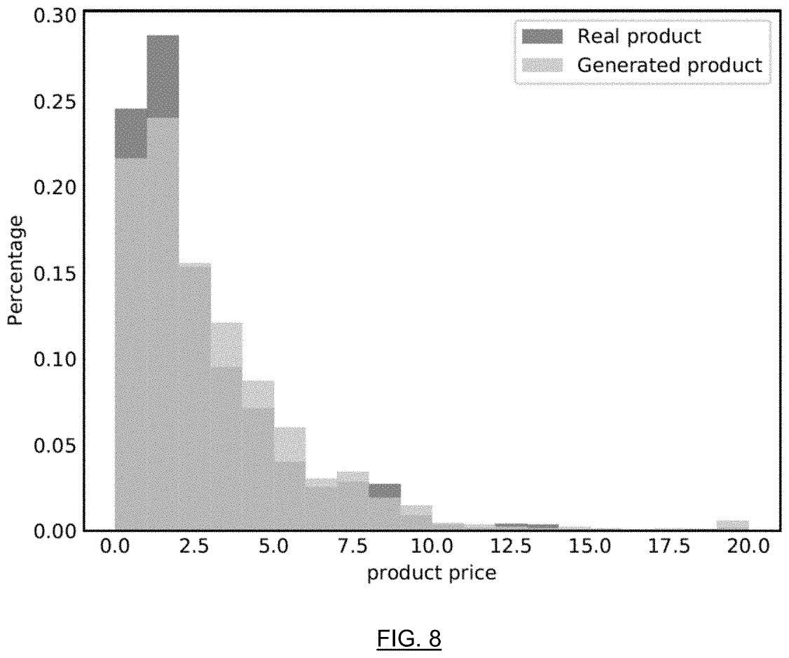

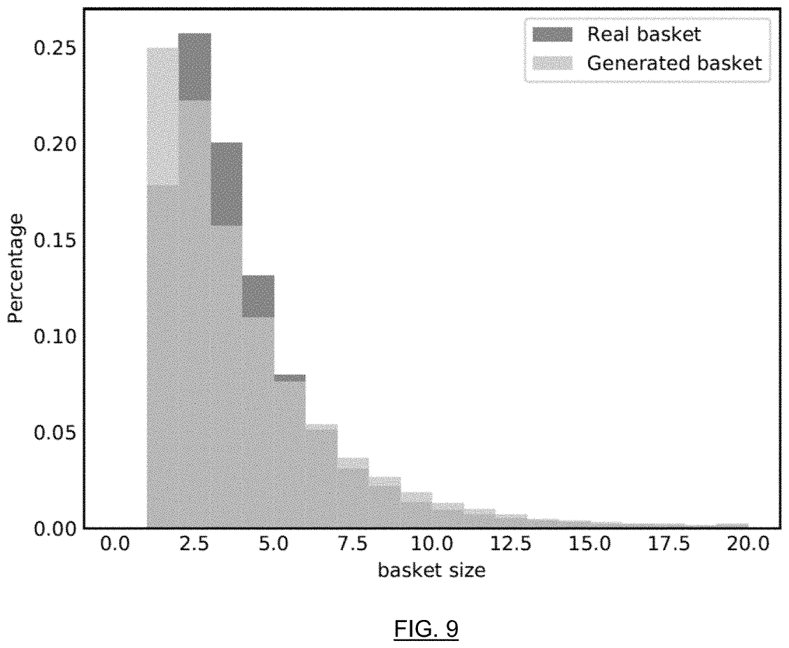

FIGS. 6, 7, 8, and 9 compare the frequency distributions of the categories, brand, prices, and basket sizes, respectively, between the baskets generated using the present embodiments and the real baskets. For the brand, the histogram plots were restricted for clarity to include only the top 30 most frequent brands. Additional metrics are provided in TABLE 1, comparing averages of the baskets for the real and generated data, and TABLE 2, showing standard deviation discrepancies between the real and generated data for various criterion. It was observed that the present embodiments could substantially replicate the ground-truth distribution. This is particularly evidenced by TABLE 2, which indicates that the highest absolute difference in frequency of generated brands is 5.6%. The lowest discrepancy occurs for the category feature, where the maximum deviation is 3.2% in the generated products. In addition, the generated basket size averages 3.85 items versus 4.08 for the real data which is a difference of approximately 5%. The generated item prices are an average of $3.1 versus $3.4 for the real data (a 10% difference). This demonstrated that the present embodiments could mimic the aggregated statistics of the real data to a substantial degree. Note that it should not be expected that the two distributions are to match exactly because the system 100 was projecting each customer's purchases into the future, which necessarily will not have the same distributive properties.

TABLE 1

| | Real | Generated |
|---|---|---|
| | Transactions | Transactions |
| Average basket size | 4.08 | 3.85 |
| Average basket price | $3.1 | $3.4 |

TABLE 2

| | Max absolute deviation |
|---|---|
| Criterion | (in %) |
| Category | 3.2% |
| Brand | 5.6% |
| Price | 5.2% |
| Basket size (only applies | 4.1% |
| for basket size ≤ 20) | |

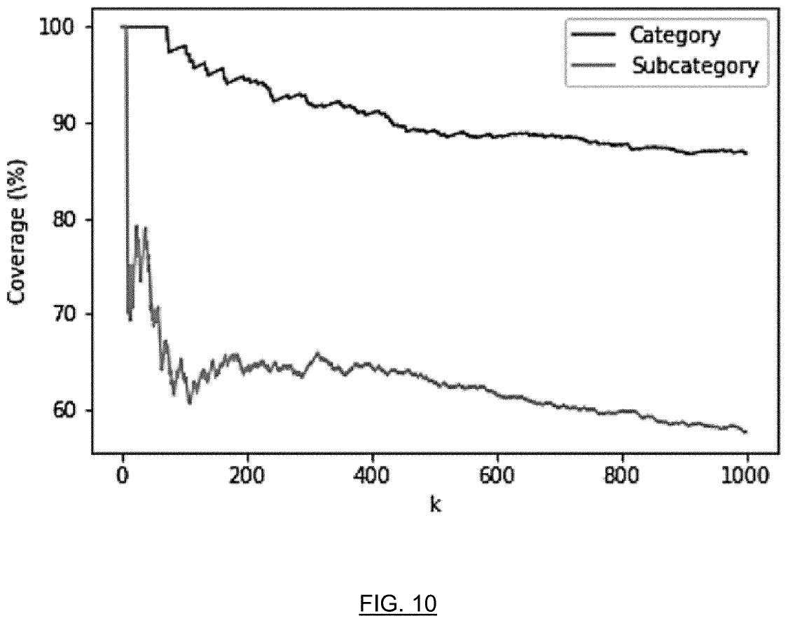

Sequential pattern mining (SPM) is a technique to discover statistically relevant subsequences from a sequence of sets ordered by time. One frequent application of SPM is in retail transactions where one wishes to determine subsequences of items across baskets customers have bought over time. For example, given an set of baskets a customer has purchased ordered by time: {milk, bread}, {cereal, cheese}, {bread, oatmeal, butter}, one sequential pattern a system can derive is: {milk}, {bread, butter} because {milk} in the first basket comes before {bread, butter} in the last basket. A pattern is typically measured by its support, which is defined as the number of customers containing the pattern as a subsequence. For the example experiments, sequential pattern mining was performed on the real and generated datasets via a sequential frequent pattern mining (SFPM) library using a minimum support of 1% of the total number of customers. FIG. 10 plots a percentage of the top-k most common real sequential patterns that are also found in the generated data as k varies from 1 to 1000. Here items were defined at either the category or subcategory level, so that two products were considered equivalent if they belonged to the same functional grouping. As shown, for the category-level, it was possible to recover 98% of the top-100 patterns, while at the subcategory level, it was possible to recover 63%. This demonstrated that the present embodiments were generating plausible sequences of baskets for customers because most of the real sequential patterns showed up in the generated data. TABLE 3 shows examples of the top sequential patterns of length 2 and 3 from the real data at the subcategory level that also appeared in the generated transactional data. The two right columns show the support for both the real and generated datasets, which is normalized by dividing by the total number of customers.

TABLE 3

| | Real | Generated |
|---|---|---|
| Sequence | support | support |
| Hemorrhoid relief, Skin treatment & dressings | 0.045 | 0.098 |
| Skin treatment & dressings, Female fine frag | 0.029 | 0.100 |
| Facial moisturizers, Skin treatment & dressings | 0.028 | 0.075 |
| Shower products, Female fine frag | 0.028 | 0.056 |
| Hemorrhoid relief, Female fine frag | 0.028 | 0.093 |
| Skin treatment & dressings, Facial moisturizers | 0.027 | 0.076 |
| Skin treatment & dressings, Preg test & ovulation | 0.027 | 0.082 |
| Shower products, Skin treatment & dressings | 0.026 | 0.056 |
| Hemorrhoid relief, Preg test & ovulation | 0.026 | 0.075 |
| Female fine frag, Preg test & ovulation | 0.025 | 0.081 |
| Facial moisturizers, Hemorrhoid relief | 0.025 | 0.069 |
| Skin treatment & dressings, Skin treatment & | 0.007 | 0.014 |
| dressings, Hemorrhoid relief | | |

Association rules are a way to discover patterns, associations or correlations, between items from transactional data Tᵣ. Such rules typically take the form of X⇒Y, where X is a set of antecedent items and Y is a set of consequent items. A common example of such product relations is that a morning breakfast is usually bought together with milk, or that potato chips are often bought with beer. Thus, association rules can serve to guide product recommendations when it is given that a customer has bought the antecedent items. In the example experiments, it was determined that the present embodiments preserved these associations. Each association rule can be characterized by the metrics of support, confidence and the lift. The support measures how frequently an item set X appears in a transactional data: Tᵣ:

$$Supp ( X ) = \frac{\vert \{ x \text{:} x ∈ {T}_{r} ⩓ X ⋐ x \} \vert}{\vert {T}_{r} \vert}$$

The confidence is the likelihood that item set Y is bought given that X is bought:

$$Conf ( X ⇒ Y ) = \frac{S u p p ( X ⋃ Y )}{S u p p ( X )}$$

where X∪Y represents the union of item sets X and Y.

The lift measures the magnitude of the dependency between item sets X and Y:

$$Lift ( X ⇒ Y ) = \frac{S u p p ( X ⋃ Y )}{S u p p ( X ) \times S u p p ( Y )}$$

A lift value strictly greater than 1 indicates high correlation between X and Y while a value of 1 means Y is unlikely to be bought if X is bought.

TABLE 4 compares association rules between the generated transactional data with ones from the real data.

TABLE 4

| | | Confidence | | Lift | |
|---|---|---|---|---|---|
| Antecedent | Consequent | Real | Generated | Real | Generated |
| Bar soap | Shower | 0.71 | 0.14 | 8.69 | 1.86 |
| | products | | | | |
| Shower | Bar soap | 0.51 | 0.10 | 8.69 | 1.86 |
| products | | | | | |
| Facial | Skin treatment | 0.37 | 0.21 | 3.28 | 1.27 |
| moisturizers | & dressings | | | | |
| Blonding | Skin treatment | 0.34 | 0.24 | 3.08 | 1.50 |
| | & dressings | | | | |
| Facial | Hemorrhoid | 0.34 | 0.19 | 3.25 | 1.24 |
| moisturizers | relief | | | | |
| Hemorrhoid | Skin treatment | 0.33 | 0.20 | 2.98 | 1.23 |
| relief | & dressings | | | | |
| Skin treatment | Hemorrhoid | 0.31 | 0.23 | 2.98 | 1.54 |
| & dressings | relief | | | | |

In TABLE 4, item sets were defined at the product category level, so that two items were considered equivalent if they belong to the same functional category. This choice reflects the intuition that a real customer's purchase decisions are influenced primarily by an item's purpose or function rather than its specific serial number, which is usually uncorrelated with that of other items in the customer's basket. The table presents the top rules with a support of at least 0.01, ordered by confidence score along with their confidence and lift for each of the real and generated data points. TABLE 4 shows that all of the strongest associations in the real data also exist in the generated data.

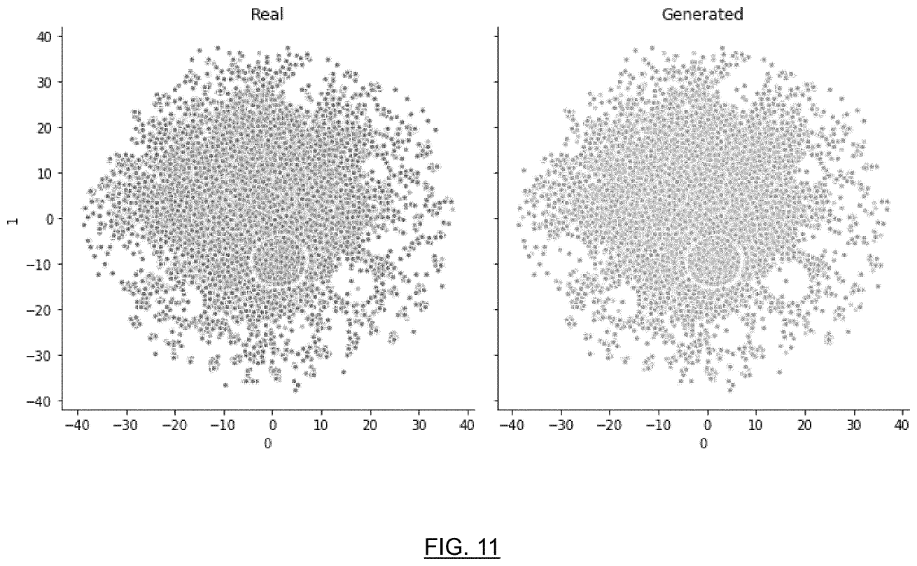

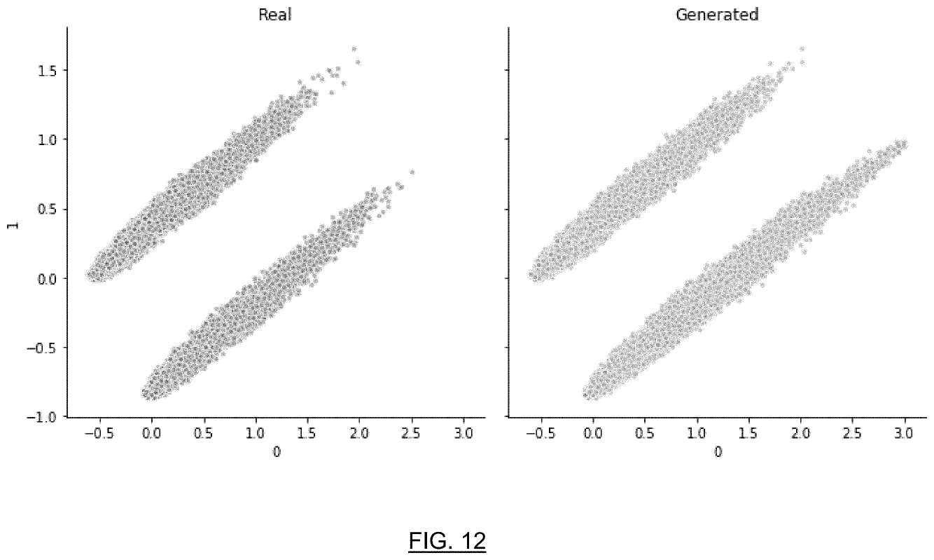

The example experiments also directly compared the generated and real baskets by the items they contained. For each basket of products Bᵢ{p_{i,j}}ⱼ₌₁^{|B}^{ᵢ}^{|}, a vector representation vᵢ was defined using a bag-of-products scheme. Where P is the set of all known products and vᵢ is a |P|-dimensional vector with vᵢ^{(j)}=1 if pⱼ∈Bᵢ or vᵢ^{(j)}=0 otherwise. P can be defined at various levels of precision such as the product serial number, the brand, or the category. At the category level, for instance, two products would be considered equivalent and correspond to the same index j if they belong to the same category. The resulting vectors were then projected into two dimensions using t-SNE for visualization purposes. The distributions of the real and generated data are plotted in FIG. 11. For an alternative viewpoint, FIG. 12 plots basket representations as bags-of-products vectors at the category level projected using Principal Component Analysis (PCA). These plots qualitatively indicate that the distributions match substantially closely.

The example experiments further analyzed the observations quantitatively by training a classifier to distinguish between points from the two distributions. By measuring the prediction accuracy of this classifier, an estimate of the degree of separability between the data sets was obtained. For the example experiments, a subset of the generated points was randomly sampled such that the number of real and generated points were equal. This way, a perfectly indistinguishable generated data set should yield a classification accuracy of 50%. It should be noted that this classification task is fundamentally unlike that which is performed by the discriminator during the GAN training, as the latter generally operates on the embedding representation of a single product while the former generally operates on the bag-of-items representation of a basket. The results are given in TABLE 5 using a logistic regression classifier. Each row corresponds to a different level of granularity in the definition of the bag-of-products representation, with category 1 being the finest-grained and stock keeping unit (sku) being the most coarse-grained. As shown, the classifier performs substantially poorly at the category levels, meaning that the generated baskets of categories are substantially plausible.

TABLE 5

| | Classification |
|---|---|
| Basket Representation | Accuracy |
| Bag-of-items category 1 | 0.634 |
| Bag-of-items category 2 | 0.663 |
| Basket embedding sku-level | 0.704 |

Accordingly, the example experiments illustrate that the present embodiments were able to generate sequences of realistic customer orders for customer-level transactional data. After learning the customer embeddings with the LSTM model, an item basket was generated conditioned on the customer embedding, using the generator from the GAN model. The generated basket of items was fed back into the LSTM model to generate a new customer embedding and the above steps were repeated. Advantageously, the present embodiments were able to substantially replicate statistics of the real data distribution (category, brand, price and basket size). Additionally, the example experiments verified that common associations exist between products in the generated and real data, and that the generated orders were difficult to distinguish from the real orders.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A method for generating at least one aspect associated with a future event for a subject using historical data, the historical data comprising a plurality of aspects associated with historical events, the method executed on at least one processing unit, the method comprising:
receiving the historical data;
determining a subject embedding using a recurrent neural network (RNN), input to the RNN comprises historical events of the subject from the historical data, each historical event comprising by an aspect embedding, the RNN trained using aspects associated with events of similar subjects from the historical data;
generating at least one aspect of the future event for the subject using a generative adversarial network (GAN), input to the GAN comprises the subject embedding, the GAN trained with subject embeddings determined using the RNN for other subjects in the historical data; and
outputting the at least one generated aspect.

2. The method of claim 1, wherein the aspect embedding comprises at least one of a moniker of the aspect and a description of the aspect.

3. The method of claim 1, wherein the RNN comprises a long short term memory (LSTM) model trained using a multi-task optimization approach.

4. The method of claim 3, wherein the multi-task optimization approach comprises a plurality of prediction tasks, the LSTM randomly sampling which of the prediction tasks to predict for each training step.

5. The method of claim 4, wherein the prediction tasks comprise:
predicting whether the aspect is a last aspect to be predicted in a compilation of aspects;
predicting a grouping or category of the aspect; and
predicting an attribute associated with the aspect.

6. The method of claim 1, wherein the GAN comprises a generator and a discriminator collectively performing a min-max game.

7. The method of claim 6, wherein the discriminator maximizes an expected score of real aspects and minimizes a score of generated aspects, and wherein the generator maximizes a likelihood that the generated aspect is plausible, where plausibility is determined by the output of the discriminator.

8. The method of claim 7, wherein the similarity of subjects is determined using a distance metric on the subject embedding.

9. The method of claim 1, further comprising generating further aspects for subsequent future events by iterating the determining of the subject embedding and the generating of the at least one aspect, using the previously determined subject embeddings and generated aspects as part of the historical data.

10. The method of claim 1, wherein aspects are organized into compilations of aspects that are associated with each of the events in the historical data and the future event.

11. A system for generating at least one aspect associated with a future event for a subject using historical data, the historical data comprising a plurality of aspects associated with historical events, the system comprising one or more processors in communication with a data storage, the one or more processors configurable to execute:
a data acquisition module to receive the historical data;
an RNN module to determine a subject embedding using a recurrent neural network (RNN), input to the RNN comprises historical events of the subject from the historical data, each historical event comprising by an aspect embedding, the RNN trained using aspects associated with events of similar subjects from the historical data; and
a GAN module to generate at least one aspect of the future event for the subject using a generative adversarial network (GAN), input to the GAN comprises the subject embedding, the GAN trained with subject embeddings determined using the RNN for other subjects in the historical data, and output the at least one generated aspect.

12. The system of claim 11, wherein the aspect embedding comprises at least one of a moniker of the aspect and a description of the aspect.

13. The system of claim 11, wherein the RNN comprises a long short term memory (LSTM) model trained using a multi-task optimization approach.

14. The system of claim 13, wherein the multi-task optimization approach comprises a plurality of prediction tasks, the LSTM randomly sampling which of the prediction tasks to predict for each training step.

15. The system of claim 14, wherein the prediction tasks comprise:
predicting whether the aspect is a last aspect to be predicted in a compilation of aspects;
predicting a grouping or category of the aspect; and
predicting an attribute associated with the aspect.

16. The system of claim 11, wherein the GAN comprises a generator and a discriminator collectively performing a min-max game.

17. The system of claim 16, wherein the discriminator maximizes an expected score of real aspects and minimizes a score of generated aspects, and wherein the generator maximizes a likelihood that the generated aspect is plausible, where plausibility is determined by the output of the discriminator.

18. The system of claim 17, wherein the similarity of subjects is determined using a distance metric on the subject embedding.

19. The system of claim 11, the one or more processors further configurable to execute a pipeline module to generate further aspects for subsequent future events by iterating the determining of the subject embedding by the RNN module and the generating of the at least one aspect by the GAN module, using the previously determined subject embeddings and generated aspects as part of the historical data.

20. The system of claim 11, wherein aspects are organized into compilations of aspects that are associated with each of the events in the historical data and the future event.
